(19) United States
(12) Patent Application Publication
(10) Pub. No.: US 2024/0356051 A1
(43) Pub. Date: Oct. 24, 2024

(54) MEDIA COMBINING DEVICE AND METHOD FOR DETECTING THE FUEL CONTENT IN MULTIPLE FUEL-CELL SYSTEMS

(71) Applicant: Robert Bosch GmbH, Stuttgart (DE)

(72) Inventor: Jochen Braun, Heimsheim (DE)

(21) Appl. No.: 18/684,745

(22) PCT Filed: Aug. 2, 2022
(86) PCT No.: PCT/EP2022/071636

§ 371 Date: Feb. 19, 2024

(30) Foreign Application Priority Data
Sep. 9, 2021 (DE) 10 2021 209 946.7

(51) Int. Cl. H01M 8/04664; H01M 8/04119; H01M 8/0444

(52) U.S. Cl. CPC H01M 8/04679; H01M 8/04179; H01M 8/04462; H01M 8/0447; H01M 2250/20

(57) ABSTRACT

The invention relates to a media combining device (M), in particular only one media combining device, preferably a common media combining device, for multiple fuel-cell systems (101, 102, 103), having the following:
a container (MB) for mixing and/or examining flows of media, the following elements being arranged on said container:
a respective line connection (M1) for each exhaust air line (12) for discharging exhaust air from a corresponding fuel-cell system (101, 102, 103),
a respective line connection (MQ1) for each purge and/or drain line (L1) of a corresponding purge and/or drain system (Q1) of an anode system of a corresponding fuel-cell system (101, 102, 103),
a line outlet (M2), in particular only one line outlet, for discharging flows of media out of the container (MB), and
at least one fuel sensor(S) for detecting the fuel content in the container (MB).

### BACKGROUND

The invention relates to a media combining device, in particular only one media combining device, preferably a common media combining device, for multiple fuel-cell systems, as well as a corresponding unit comprising multiple fuel-cell systems, e.g. for a vehicle, and a corresponding media combining device according to the disclosure. The invention further relates to advantageous uses of a corresponding media combining device, as well as a method for detecting the fuel content, for diagnosing a fuel leakage, for determining a source of a fuel leakage, for checking a fuel mass flow, and/or for diluting a fuel mass flow in a corresponding unit comprising multiple fuel-cell systems and a corresponding media combining device according to the disclosure.

Fuel-cell systems, also in the form energy suppliers in vehicles, are known. In fuel-cell systems, oxygen from the ambient air is generally used as an oxidizing agent and fuel or hydrogen is generally used as a reducing agent in order to react to water (or water vapor) in the fuel-cell stack of the system and to therefore supply an electrical power by electrochemical conversion. The ambient air is provided to the fuel-cell stack mostly by means of a cathode system having an air compression system. The hydrogen is generally stored in a high-pressure tank (e.g., 700 bar) and supplied to the fuel-cell stack via lines and valves and recirculated in a loop-like anode path of an anode system. In operation, the anode loop must be rinsed (“purge”) and dewatered (“drain”) in a periodic manner in order to lower the increasing nitrogen content (by diffusion via the membrane) and the sufficient water in the anode. A part of the purge gas in this case is also hydrogen, for which reason the purge gas is directed into the air system exhaust channel and diluted there through the air mass flow to the extent that no explosive mixture can be produced.

The fuel-cell stack typically comprises multiple fuel-cells that are sealed against one another using many seals. However, these seals are subjected to temperature changes, pressure changes, etc., and age accordingly. Therefore, the fuel-cell stacks are usually not sealed in the absolute sense. On the other hand, the high-pressure tanks for storing the hydrogen or its fittings, actuators, sensors, and/or pipes can leak.

Given that hydrogen is very volatile and can form an explosive mixture with air, especially in confined or enclosed spaces, it is relevant to safety to identify any possible hydrogen leaks. A plurality of hydrogen sensors are typically installed for hydrogen leakage detection. These sensors are associated with significant costs. When used in the vehicle, a plurality of multiple hydrogen sensors are usually required at various locations. In addition, if hydrogen leakages cannot be excluded in limited spaces, aeration systems are generally used to ensure a sufficiently high air exchange and to avoid hydrogen accumulations that could lead to explosive mixtures.

A further system-inherent property in fuel-cell systems is the development of product water (reaction product from hydrogen and oxygen from the air).

### SUMMARY

According to a first aspect, the invention provides a media combining device, in particular only one media combining device, preferably a common media combining device, for multiple fuel-cell systems and, according to a second aspect, a corresponding unit comprising multiple fuel-cell systems, e.g. for a vehicle, and a corresponding media combining device. Furthermore, according to third, fourth, and fifth aspects, the invention provides advantageous uses of a corresponding media combining device as well as, according to sixth aspect, a method for detecting the fuel content, for diagnosing a fuel leakage, for determining a source of a fuel leakage, for checking a fuel mass flow, and/or for diluting a fuel mass flow in a corresponding unit comprising multiple fuel-cell systems, and a corresponding media combining device. Further advantages, features, and details of the invention arise from the description and the drawings. In this context, features and details described in connection with individual aspects according to the invention clearly also apply in connection with the other aspects according to the invention and respectively vice versa so that, with respect to the disclosure, mutual reference to the individual aspects of the invention is or can always be made.

According to the first aspect, the present invention provides a media combining device for multiple fuel-cell systems comprising:
a container for mixing and/or examining flows of media, the following elements being arranged on said container:
a respective line connection for each exhaust air line for discharging exhaust air from a corresponding fuel-cell system,
a line connection for each purge and/or drain line of a corresponding purge and/or drain system of an anode system of a corresponding fuel-cell system,
a line outlet, in particular only one line outlet, for discharging flows of media out of the container, and
at least one fuel sensor for detecting the fuel content in the container.

The multiple fuel-cell systems can advantageously form a unit. The multiple fuel-cell systems can be used, for example, for mobile applications, e.g. in motor vehicles, or for stationary applications, e.g. in generator systems.

Each fuel-cell system of the multiple fuel-cell systems can thereby comprise at least one fuel-cell stack (abbreviated as stack). Each fuel-cell stack can advantageously be designed to have a stack aeration system for aeration of the close or immediate surroundings of the stack.

Furthermore, each fuel-cell system of the multiple fuel-cell systems can comprise a cathode system for providing an oxygen-containing reactant to the at least one fuel-cell stack. Each cathode system can comprise an air supply line for providing an air supply to the at least one fuel-cell stack and an exhaust air line for discharging exhaust air from the at least one fuel-cell stack.

Furthermore, each fuel-cell system of the multiple fuel-cell systems can comprise an anode system for providing a fuel-containing reactant to the at least one fuel-cell stack.

The anode system can further comprise a purge and/or drainage system for flushing the anode path and/or for discharging product water from the anode path. The purge and/or drain system can further comprise at least one combined purge and/or drain line (which can also be referred to as a purge and/or drain outlet line) or a separate purge line and drain line. In other words, the purge and drain system can be combined (one valve and one line) or implemented separately (one purge valve comprising a purge line and one drain valve comprising a drain line).

The fuel-cell systems can further comprise a common, preferably modular, tank system having one or more cylinders for each fuel-cell system. The tank system can be designed to have a tank aeration system for aeration of the close or immediate surroundings of the tank system.

The stack aeration system can comprise a stack deaeration line to discharge the gas or mixture used to vent the close or immediate surroundings of the stack from the stack surroundings. For aeration, the respective stack can be arranged in an additional housing or at least partially in an additional housing.

The tank aeration system can comprise a tank deaeration line (which in turn can lead into one or more tank deaeration lines for each tank enclosure) to discharge the gas or mixture used to vent the close or immediate surroundings of the tank system out of the tank system surroundings. For aeration, the tank system can be arranged in an additional housing or at least partially in an additional housing.

Therefore, with the aid of the media combining device according to the invention, one or two fuel sensor(s), e.g. in the form of hydrogen sensor(s), can be provided for multiple fuel-cell systems and in particular for the entire vehicle.

The media combining device can advantageously be connected downstream of respective exhaust air lines of corresponding cathode systems of corresponding fuel-cell systems. In other words, all exhaust air lines of all cathode systems from the multiple fuel-cell systems can be connected downstream of the media combining device, particularly fluidically, and/or lead into the media combining device and/or flow together into the media combining device.

The term “downstream” in the exhaust air line can mean approximately at the end of the exhaust air line, whereby only one muffler can be arranged in the outlet line after the media combining device according to the invention comprising the one fuel sensor, in particular only one for the multiple fuel-cell systems and in particular for the entire vehicle.

It can further be provided that all purge and/or drain lines of all anode systems, all stack deaeration lines, and/or all tank deaeration lines of the multiple of fuel-cell systems can be connected, in particular fluidically, to the media combining device according to the invention.

Furthermore, all lines that can be intentional and/or unintentional sources of fuel, in particular hydrogen, can be combined in the media combining device.

The container of the media combining device receives the exhaust air from all stacks, the purge and/or drain gas, and preferably other flows of media from the fuel-cell systems, mixes the media, cools the media, inspects the media, and dilutes the media, preferably before discharging it to the surroundings. The flows of media are discharged from the container through the line outlet, in particular only one line outlet.

The invention therefore provides an optimized unit comprising multiple fuel-cell systems, including an improved detection method, which will be discussed in detail hereinafter, comprising a minimum number of fuel sensors, preferably comprising only one or two fuel sensors in the entire unit.

The essence of the invention lies in the fact that only one or two fuel sensors can be used for all fuel-cell systems, as well as in particular for the entire vehicle.

Advantageously, the fuel sensor can be integrated on or into the media combining device.

Sources of fuel include at least the at least one purge and/or a drain line (intentional source of fuel mass flow) of an anode system, the stack cathode path or the exhaust air line of the stack cathode path, optionally the stack deaeration line (unintentional source of fuel leakage), optionally the tank deaeration line, whereby further aeration systems and/or sources of possible fuel leakages as well as fuel mass flows can be fluidically connected to the media combining device in the same way as the deaeration lines specified.

One advantage of the invention is that the detection of a fuel content, the diagnosis of a fuel leakage, the determination of a source of a fuel leakage, a check of a fuel mass flow and/or a dilution of a fuel mass flow can be performed at one point, i.e. in the media combining device.

Advantageously, the fuel accumulations can be diluted at least by the bypass air of the stack cathode path and/or the exhaust air of one or more cathode systems and/or air from aeration systems.

With the aid of the media combining device according to the invention, a diagnostic method and/or a monitoring method using pin pointing, i.e., detection from which fuel-cell system and also from which source the hydrogen leakage or the hydrogen mass flow originates, can be performed. The connection of the aeration system for the tank system and/or the aeration system for the stack to the media combining device helps to reliably detect, dilute, and discharge the fuel accumulated in the respective systems.

A further advantage of the invention is that the media combining device can be used to discharge water to the surroundings or to discharge water to another functional system of the fuel-cell system and/or to a container for further use.

In addition, it is advantageous that the at least one fuel sensor can be easily calibrated to a zero value using the bypass air of one or more cathode systems. When using two sensors, these can be matched and/or used for mutual monitoring. In addition, it is conceivable that the at least one fuel sensor can be calibrated using a selectively adjusted purge and/or drain mass flow at further operating points.

Furthermore, it can be advantageous that dilution of the drain and/or purge, gas, and/or fluid mixtures can be performed by means of a secondary mass air flow, e.g., a fresh air fan of an interior vehicle space and/or a separate aeration fan which can, e.g., be used to aerate the stacks and/or the tank system. In this way, a decoupling from the air compressor operation and/or a redundancy to the air compressor operation can be created in the respective cathode systems. However, a decoupling from the cathode system and/or a redundancy can also be created for the aeration systems of the tank system and/or the stacks. Advantageously, with the aid of the invention, secondary air systems in the vehicle, e.g., air systems of a vehicle interior, a tank system, a trunk system, etc., also do not require separate fuel sensors.

If two fuel sensors are arranged on the container, a redundancy for safety reasons and/or the possibility that the fuel sensors can be used for mutual checking can be created.

Furthermore, a media combining device can be provided with a water outlet arranged on the container for discharging water. In this way, the media combining device can be used as a water separation device equipped with a water outlet specifically designed for this purpose. However, it is also conceivable that the media combining device can be designed without a separate water outlet. In the latter case, the water can be discharged from the fuel-cell system through the outlet line.

It can further be provided in a media combining device that the water outlet is arranged at the lowest point of the container when the container is in the position of use. Water separation can be favored thereby.

It can further be provided in a media combining device that the water outlet is arranged lower than the line outlet for discharging flows of media out of the container in a position of use of the container. Water separation from the exhaust air of the fuel-cell systems can be favored thereby. In this way, the line outlet can be provided with an advantageous overflow function for discharging flows of media from the container.

As previously mentioned hereinabove, at least one of the following elements can additionally be arranged on the container:
a line connection for a stack deaeration line of a stack aeration system,
a line connection for a tank deaeration line of a tank aeration system, and/or
a line connection for a deaeration line of a further aeration system,
e.g., supplied by means of a fresh air fan of a vehicle interior and/or a separate aeration fan and/or from air compression systems of the cathode paths.

The further aeration system can aerate further areas with a potential risk of hydrogen accumulations, e.g. when H2-carrying components such as lines, valves, etc. The media combining device can therefore be provided with enhanced functionality to unfold the advantages according to the invention, e.g. diagnosing a leakage and pin pointing as well as water separation, water discharge, and/or water supply, even for other possible aeration systems in a fuel-cell system and/or a corresponding vehicle.

Advantageously, the container can comprise at least one drainage surface. The drainage surface can favor the drainage of water from the container. It is conceivable that the drainage surface is in this case inclined in a position of use of the container. In addition, it is conceivable that the drainage surface is free of connections and/or outlets. In this way, the drainage surface can direct the separated water directly to the provided water outlet or to the pipe outlet.

Furthermore, it can be advantageous if the container is designed to be ice-resistant and/or freeze-resistant. In this way, the media combining device can also be used in unfavorable weather conditions, e.g. during a freeze start or cold start of the fuel-cell system.

Moreover, it can be advantageous if the container is designed to be explosion-proof. In this way, the risk of explosion in the fuel-cell system can be significantly reduced and can even be localized on the container in order to bring it to succumb it.

In the case of a media combining device, it can also be advantageous if the line connections and the line outlet are distributed on the container and/or have diameters such that at least one effect for mixing the flows of media is achieved:
deflection,
turbulence,
swirl flow,
heat transfer, and/or
cooling.

In this way, the mixing of the flows of media potentially containing hydrogen can be favored within the container.

The line connections on the container which are not used can in turn each be sealed by a blind plug for the sake of simplicity. With the aid of the invention, a standardized media combining device can be provided for different topologies of differently designed fuel-cell systems.

According to the second aspect, the invention provides a unit comprising multiple fuel-cell systems and a media combining device, in particular only one media combining device, preferably a common media combining device, which can be designed as described hereinabove, whereby the media combining device is connected downstream to a respective exhaust air line of a corresponding cathode system of a corresponding fuel-cell system. With the aid of the unit within the meaning of the invention, advantageous mobile and stationary uses of multiple fuel-cell systems can be provided. Furthermore, with the aid of the unit according to the invention, the same advantages are achieved as described hereinabove in connection with the media combining device according to the invention. In the present case, explicit reference to these advantages is made.

According to the third aspect, the invention provides: a use of a media combining device, which can be designed as described hereinabove, for detecting a fuel content, for diagnosing a fuel leakage, for determining a source of fuel leakage, for checking a fuel mass flow and/or for diluting a fuel mass flow in a unit having multiple fuel-cells systems.

According to the fourth aspect, the invention provides: a use of a media combining device, which can be designed as described hereinabove, to discharge water to surroundings and/or discharge water to a functional system and/or to a storage system of a unit.

According to the fifth aspect the invention provides: a use of a media combining device, which can be designed as described hereinabove, for calibrating and/or checking a fuel sensor and/or for matching multiple fuel sensors.

According to the sixth aspect, the invention provides: a method for detecting the fuel content, for diagnosing a fuel leakage, for determining a source of a fuel leakage, for checking a fuel mass flow and/or for diluting a fuel mass flow in a unit, which can be designed as described hereinabove, whereby the method is performed during normal operation and/or during an investigative operation (if there is a suspected incident of an unintentional fuel leakage) of at least one of the multiple of fuel-cell systems of the unit.

Advantageously, during normal operation of the units, the fuel content can be monitored from all sources of the respective active paths of the units fed into the media combining device. All fuel-cell systems can thereby be operated without a change in operation. For this purpose, at least one threshold value can be determined, which is not allowed be exceeded. Advantageously, this threshold value is dependent on the operating point or state. If the threshold value is exceeded, a suspected incident of an unintentional fuel leakage can be detected. A certain debounce time can optionally be waited for after exceeding the threshold value regarding whether the fuel content remains above the threshold value. An investigative operation can then be initiated.

Additional procedures that are more in-depth can optionally be initiated in the event of an investigative operation. In this case, the fuel content can be checked from individual fuel-cell systems of the unit and/or from individual functional systems of a corresponding fuel-cell system. Advantageously, all fuel-cell systems can thereby be checked in succession. Within the fuel-cell systems, the respective functional systems can also be checked in succession. In an investigative operation, the fuel-cell systems can undergo an operational change and, e.g., be placed in a standby mode. For example, the respective shut-off valves for the cathode chamber of the respective stack can be closed and the respective cathode system can be operated in bypass operation of the stack cathode path.

Advantageously, a vehicle having a unit comprising multiple fuel-cell systems and a media combining device, which can be designed as described above, can also represent an aspect of the invention.

### BRIEF DESCRIPTION OF THE DRAWINGS

The invention and the embodiments as well as the advantages thereof are explained in further detail hereinafter with reference to the drawings. Schematically shown are:

FIG. 1 a schematic representation of a media combining device within the meaning of the invention,

FIG. 2 a schematic representation of a media combining device within the meaning of the invention,

FIG. 3 a schematic representation of a media combining device within the meaning of the invention, and

FIG. 4 a schematic representation of a sequence of a method within the meaning of the invention.

### DETAILED DESCRIPTION

In the various drawings, identical aspects of the invention are always indicated by identical reference characters, for which reason said parts are typically only described once.

FIGS. 1 to 3 show a media combining device M for multiple fuel-cell systems 101, 102, 103 comprising:
a container MB for mixing and/or examining flows of media, the following elements being arranged on said container:
a respective line connection M1 for each exhaust air line 12 for discharging exhaust air from a corresponding fuel-cell system 101, 102, 103,
a respective line connection MQ1 for each purge and/or drain line Ll of a corresponding purge and/or drain system Q1 of an anode system of a corresponding fuel-cell system 101, 102, 103,
a line outlet M2, in particular only one line outlet, for discharging flows of media out of the container MB, and
at least one fuel sensor S for detecting the fuel content in the container MB.

In the drawings, three fuel-cell systems 101, 102, 103 are provided, but two or more than three fuel-cell systems 101, 102, 103 can also be provided, for which only one media combining device M is provided.

As indicated in FIGS. 1 to 3, the multiple fuel-cell systems 101 102, 103 form a unit 100 that also represents an aspect of the invention. The unit 100 or the multiple of fuel-cell systems 101, 102, 103 can, e.g., be used for mobile applications, e.g. in motor vehicles, or for stationary applications, e.g. in generator systems.

Each fuel-cell system 101, 102, 103 can in this case comprise at least one fuel-cell stack (abbreviated as stack), which is not shown for the sake of simplicity. Each fuel-cell stack can advantageously comprise a stack aeration system Q2 for aeration of the close or immediate surroundings of the stack.

The stack aeration system Q2 can comprise a stack deaeration line L2 to discharge the gas or gas mixture used to vent the close or immediate surroundings of the stack from the stack surroundings. The respective stack can be arranged in an additional housing or at least partially in an additional housing for aeration.

Furthermore, each fuel-cell system 101, 102, 103 can comprise a cathode system 10 for providing an oxygen-containing reactant to the at least one fuel-cell stack. Each cathode system 10 can comprise an air supply line for providing an air supply to the at least one fuel-cell stack and an exhaust air line 12 for discharging exhaust air from the at least one fuel-cell stack.

Each fuel-cell system 101, 102, 103 of the multiple fuel-cell systems can further comprise an anode system (not shown for the sake of simplicity) for providing a fuel-containing reactant to the at least one fuel-cell stack.

The anode system can in this case comprise a purge and/or drainage system Q1 for flushing the anode path and/or for discharging product water from the anode path. The purge and/or drain system Q1 can further comprise at least one combined purge and/or drain line L1 (which can also be referred to as a purge and/or drain outlet line) or a separate purge line and drain line.

The fuel-cell systems 101, 102, 103 can further comprise a common, preferably modular, tank system having one or more cylinders for each fuel-cell system. The tank system can comprise a tank aeration system Q3 for aeration of the close or immediate surroundings of the tank system.

The tank aeration system Q3 can comprise a tank deaeration line L3 (which in turn can lead into one or more tank deaeration lines for each tank enclosure) to discharge the gas or mixture used to vent the close or immediate surroundings of the tank system out of the tank system surroundings. The tank system can be arranged in an additional housing or at least partially in an additional housing for aeration.

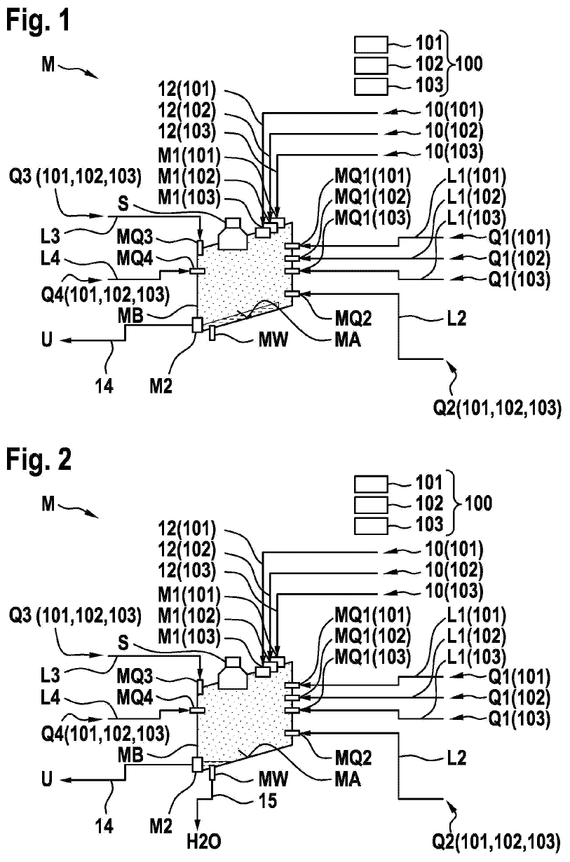

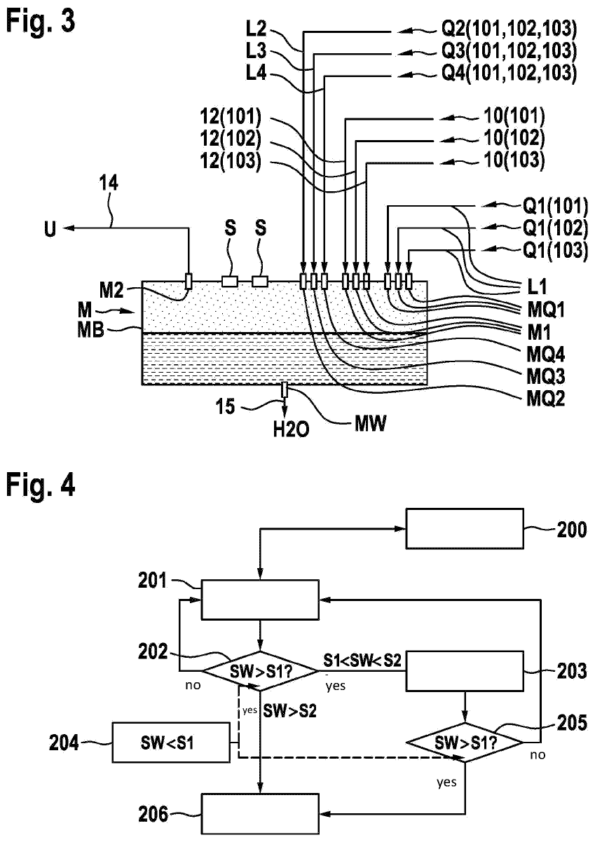

As FIGS. 1 to 3 illustrate, one (see FIGS. 1 and 2) or two (see FIG. 3) fuel sensor(s) S, e.g. in the form of hydrogen sensor(s), can be provided for the multiple fuel-cell systems 101, 102, 103 and in particular for the entire vehicle with the aid of the media combining device M according to the invention.

As FIGS. 1 to 3 further illustrate, the media combining device M can advantageously be connected downstream of respective exhaust air lines 12 of corresponding cathode systems 10 of corresponding fuel-cell systems 101, 102, 103. In other words, all exhaust air lines 12 of all cathode systems 10 from the multiple fuel-cell systems 101, 102, 103 can be connected, in particular fluidically connected, downstream of the media combining device M, and/or lead into the media combining device M and/or flow together in the media combining device M.

The term “downstream in the exhaust air line 12” can be understood to mean at the end of the exhaust air line 12, such that the media combining device M is arranged at the end of the exhaust air line 12, whereby only one outlet line 14 to the surroundings U, optionally using a muffler, can be arranged after the media combining device M according to the invention.

As further illustrated by FIGS. 1 to 3, all purge and/or drain lines L1 (intentional sources Q1 of fuel mass flow) of all anode systems, all stack cathode paths or the exhaust air lines of the stack cathode paths, all stack deaeration lines L2 (unintentional sources Q2 of fuel leakage) and/or all tank deaeration lines L3 (unintentional sources Q3 of fuel leakages) of the multiple of fuel-cell systems 101, 102, 103 can be connected, in particular fluidically connected, to the media combining device M according to the invention.

In other words, all lines L1, L2, L3, L4, 12 can be combined into the media combining device M, which can be intentional and/or unwanted sources Q1, Q2, Q3, Q4, 10 of fuel, particularly hydrogen.

The container MB of the media combining device receives the exhaust air from all stacks, the purge and/or drain gas, and preferably other flows of media from the fuel-cell systems 101, 102, 103, mixes the flows of media, cools them, inspects the media, dilutes the flows of media, preferably before they are discharged to the surroundings U via one, in particular only one, line outlet M2 and one, in particular only one, outlet line 14. The flows of media are therefore discharged from the container MB through a single line outlet M2.

An optimized unit 100 can therefore be provided with multiple fuel-cell systems 101, 102, 103 having only one or two fuel sensor(s) in the entire unit 100.

The fuel sensor S can in this case be integrated at or into the media combining device M.

Advantageously, the detection of a fuel content, the diagnosis of a fuel leakage, the determination of a source of a fuel leakage, a check of a fuel mass flow, and/or a dilution of a fuel mass flow can be performed at one point in the media combining device M.

Advantageously, the fuel accumulations can be diluted at least by the bypass air of the stack cathode path and/or the exhaust air of one or more cathode systems 10 and/or air from aeration systems.

With the aid of the media combining device according to the invention, a diagnostic method and/or a monitoring method using pin pointing, i.e. detection from which fuel-cell system 101, 102, 103 and also from which source Q1, Q2, Q3, Q4, 10 the hydrogen leakage or the fuel hydrogen mass flow originates, can be performed.

In addition, the media combining device M can serve to discharge water to the surroundings U or to discharge water to another functional system of the fuel-cell system 101, 102, 103 and/or to a specific container for further use.

In addition, the at least one fuel sensor S can be calibrated using the media combining device M, for example to a zero value using a bypass air of the stack cathode bypass of one or multiple cathode systems 10. When using two sensors S, the sensor values can be matched and/or used for mutual monitoring. In addition, it is conceivable that the at least one fuel sensor S of a selectively adjusted purge and/or drain mass flow can be calibrated at further operating points.

Furthermore, the dilution of the drain and/or purge gas and/or fluid mixture can be performed by means of a secondary air mass flow, e.g. a fresh air fan of a vehicle interior and/or a separate aeration fan which can, e.g., be used to aerate the stacks and/or the tank system. In this way, a decoupling from the air compressor operation and/or a redundancy to the air compressor operation can be created in the respective cathode system 10. However, a decoupling from the cathode systems 10 and/or a redundancy can also be created for the aeration systems of the tank system and/or the stacks. Advantageously, with the aid of the invention, secondary air systems in the vehicle, e.g. air systems of a vehicle interior, a tank system, a trunk system, etc. also do not require separate fuel sensors S.

As also shown in FIGS. 2 and 3, a water outlet MW for discharging water H2O can be arranged on the container MB.

As shown in FIG. 1, in a position of use of the container MB, the water outlet MW can be integrated into the line outlet M2, so that the water can be discharged to the surroundings by means of the line outlet M2 and the outlet line 14 (no separate water use).

As shown in FIG. 2, in a position of use of the container MB, the water outlet MW can be arranged lower than the line outlet M2 for discharging flows of media from the container MB in order to favor water separation from the exhaust air of the fuel-cell systems 101, 102, 103 and to collect water. In this way, the line outlet M2 can be provided with an overflow function for discharging flows of media from the container MB.

As previously mentioned hereinabove, at least one of the following elements can additionally be arranged on the container MB:
a line connection MQ2 for a stack deaeration line L2 of a stack aeration system Q2,
a line connection MQ3 for a tank deaeration line L3 of a tank aeration system Q3, and/or
a line connection MQ4 for a deaeration line L4 of a further aeration system Q4,
e.g., supplied by means of a fresh air fan of a vehicle interior and/or a separate aeration fan and/or from air compression systems of the cathode paths.

It is shown in FIGS. 1 and 2 that the container MB can have at least one drainage surface MA in order to favor the drainage of water H2O from the container MB. In a position of use of the container MB, the drainage surface is positioned at an angle. The separated water is led directly to the provided water outlet MW (see FIG. 2) or to the pipe outlet M2 (see FIG. 1) via the drainage surface MA. In the example in FIG. 1, the water outlet MW can be closed by a blind plug if the water outlet MW is not used.

It can further be provided that the container MB is designed to be ice-resistant and/or freeze-resistant. It can further be provided that the container MB can be designed to be explosion-proof.

The line connections M1, MQ1, MQ2, MQ3, MQ4 and the line outlet M2 can be preferably distributed on the container MB and/or have such diameters that at least one effect for mixing the flows of media is achieved:
deflection,
turbulence,
swirl flow,
heat transfer, and/or
cooling.

The line connections M1, MQ1, MQ2, MQ3, MQ4, and the line outlet M2 on the container, which are not used, can be closed by a blind plug for the sake of simplicity.

FIG. 4 serves to illustrate a possible procedure of a method within the meaning of the invention for detecting a fuel content, for diagnosing a fuel leakage, for determining a source of a fuel leakage, for checking a fuel mass flow and/or for diluting a fuel mass flow in a unit 100, which can comprise multiple fuel-cell systems 101, 102, 103 and a media combining device, which can be designed as described hereinabove.

The method can first be performed during normal operation 201 to 205 and, when a suspected incident is detected, during investigative operation 206 of at least one of the multiple fuel-cell systems 101, 102, 103 of the unit 100.

First, in step 200, the at least one fuel sensor S can be calibrated and/or the fuel sensors S, if two are present, can be matched.

In step 201, the method can be initiated or continuously operated for monitoring at regular intervals, preferably on a regular basis, during normal operation 201 to 205 of the unit 100.

In step 202 the fuel content from all sources 101, 102, 103, Q1, Q2, Q3, Q4, 10 of the unit 100 can be monitored:
Sensor value SW>threshold value S1?

All fuel-cell systems 101, 102, 103 can be operated without a change in operation.

The threshold value S1 can be determined using substance data, empirical values, histories, models, estimates depending on the operation point and/or state.

Exceeding the threshold value S1 can detect a suspected incident of an unintentional fuel leakage in step 203.

In step 205, a certain debounce time can be waited for after exceeding the threshold value S1 in order to verify whether the fuel content remains above the threshold value S1 for an applicable time, or whether the fuel content is normalizing, as schematically indicated by the connection from 205 to 201.

If the sensor value SW is above the threshold value S1 even after the debounce time, an investigative operation can be initiated in step 206.

In addition, a further threshold value S2 can be determined which can be selected higher than the threshold value S1 which requires an immediate initiation of an investigation operation in step 206:
Sensor value SW>threshold value S2?

In an investigative operation, further methods that are optionally more in depth for detecting the fuel content, for diagnosing a fuel leakage, for determining a source of a fuel leakage, for checking a fuel mass flow, and/or for diluting a fuel mass flow can be initiated.

In an investigation operation, the fuel content can be checked from individual fuel-cell systems 101, 102, 103 of the unit and/or from individual functional systems of a corresponding fuel-cell system (100).

For that sake of simplicity, all fuel-cell systems 101, 102, 103 can be checked in sequence.

Within the fuel-cell systems 101, 102, 103, the respective functional systems can also be checked, whereby the order can change as desired and/or as needed:
the cathode system 10,
the purge and/or drainage system Q1,
the stack aeration system Q2,
the tank aeration system Q3,
optionally, a further aeration system Q4, etc.

In an investigative operation, the fuel-cell systems 101, 102, 103 can undergo an operational change and, for example, can be placed in a standby mode. A standby mode can be a bypass operation mode. For example, the respective shut-off valves for the cathode chamber of the respective stack can be closed and the respective cathode system 10 can be operated in bypass operation.

A vehicle 1 having a corresponding fuel-cell system 101, 102, 103, in which a media combining device M according to the invention is provided downstream in the exhaust air line 12 of the cathode system 10, can also represent an aspect of the invention.

The description hereinabove of the drawings merely describes the present invention by way of examples. Of course, individual features of the embodiments can be freely combined with one another, insofar as technically sensible, without leaving the scope of the invention.

1. A media combining device (M) for multiple fuel-cell systems (101, 102, 103) having the following:
a container (MB) for mixing and/or examining flows of media, the following elements being arranged on said container:
a respective line connection (M1) for each exhaust air line (12) for discharging exhaust air from a corresponding fuel-cell system (101, 102, 103),
a respective line connection (MQ1) for each purge and/or drain line (L1) of a corresponding purge and/or drain system (Q1) of an anode system of a corresponding fuel-cell system (101, 102, 103),
a line outlet (M2) for discharging flows of media out of the container (MB), and
at least one fuel sensor(S) for detecting a fuel content in the container (MB).

2. The media combining device (M) according to claim 1, wherein
two fuel sensors(S) are arranged on the container (MB).

3. The media combining device (M) according to claim 2, wherein
a water outlet (MW) for discharging water is arranged on the container (MB), and/or wherein, in a position of use of the container (MB), a/the water outlet (MW) is arranged at a lowest point of the container (MB),
and/or, wherein in a position of use of the container (MB), a/the water outlet (MW) is arranged lower than the line outlet (M2) for draining flows of media from the container (MB),
and/or wherein the line outlet (M2) is arranged to discharge flows of media from the container (MB) using an overflow function,
and/or wherein the water outlet (MW) is integrated into the line outlet (M2).

4. The media combining device (M) according to claim 1,
wherein
at least one of the following elements is arranged on the container (MB):
a line connection (MQ2) for a stack deaeration line (L2) of a stack aeration system (Q2),
a line connection (MQ3) for a tank deaeration line (L3) of a tank aeration system (Q3), and/or
a line connection (MQ4) for a deaeration line (L4) of a further aeration system (Q4),
supplied by fresh air fan (IN) of a vehicle interior, and/or a separate aeration fan (BG), and/or from air compression systems of cathode paths.

5. The media combining device (M) according to claim 1,
wherein
the container (MB) comprises at least one drainage surface (MA),
wherein, in a position of use of the container (MB), the drainage surface (MA) can be positioned at an angle,
wherein the drainage surface (MA) is free of connections and/or outlets,
and/or wherein the container (MB) is configured to be ice-resistant and/or freeze-resistant.

6. The media combining device (M) according to claim 1,
wherein
the line connections (M1, MQ1, MQ2, MQ3, MQ4) and the line outlet (M2) are distributed on the container (MB) and/or include such diameters that at least one effect for mixing the flows of media is achieved:
deflection,
turbulence,
swirl flow,
heat transfer, and/or
cooling,
and/or that wherein the line connections (M1, MQ1, MQ2, MQ3, MQ4) on the container (MB) are each sealed by blind plugs, which are not used in the fuel-cell system (101, 102, 103).

7. A unit (100), comprising:
multiple fuel-cell systems (101, 102, 103), and
a media combining device (M), according to claim 1,
wherein the media combining device (M) is connected downstream to a respective exhaust air line (12) of a respective cathode system (10) of a corresponding fuel-cell system (101, 102, 103).

8. The use of a media combining device (M) according to claim 1 in a method for detecting the fuel content, for diagnosing a fuel leakage, for determining a source of a fuel leakage, for checking a fuel mass flow, and/or for diluting a fuel mass flow in a unit.

9. The use of a media combining device (M) according to claim 1 in order to discharge water to a surrounding area and/or to discharge water to a functional system and/or a storage system of a unit.

10. The use of a media combining device (M) according to claim 1 for calibrating and/or checking a fuel sensor(S) and/or for matching multiple fuel sensors(S).

11. A method for detecting a fuel content, for diagnosing a fuel leakage, for determining a source of a fuel leakage, for checking a fuel mass flow, and/or for diluting a fuel mass flow in a unit (100) according to claim 7,
wherein the method is performed during normal operation and/or during investigative operation of at least one of the multiple fuel-cell systems (101, 102, 103) of the unit (100).

12. The method according to claim 11, wherein,
during normal operation of the unit (100), the fuel content from all sources of the unit (100) is monitored,
and/or that the fuel content from individual fuel-cell systems (101, 102, 103) of the unit (100) and/or from individual functional systems of a corresponding fuel-cell system (101, 102, 103) is checked during the investigative operation of the unit (100).

13. The media combining device (M) according to claim 1, wherein the line outlet (M2) includes only one line outlet.

14. The unit (100) according to claim 7, wherein the media combining device (M) is only one media combining device and is a common media combining device (M).
